(19) United States
(12) Patent Application Publication
(10) Pub. No.: US 2017/0094022 A1
(43) Pub. Date: Mar. 30, 2017

(54) SYSTEMS AND METHODS FOR FINGERPRINTING OPERATING SYSTEMS AND SOFTWARE APPLICATIONS BASED ON NETWORK RESOURCE ACCESS PATTERN

(71) Applicant: Limited Liability Company Mail.Ru, Moscow (RU)

(72) Inventor: Ilnar Firsorovich BORKHANOV, Khimki (RU)

(21) Appl. No.: 15/190,206

(22) Filed: Jun. 23, 2016

Related U.S. Application Data
(63) Continuation of application No. PCT/RU2013/001202, filed on Dec. 30, 2013.

(51) Int. Cl. H04L 29/08; H04L 29/12

(52) U.S. Cl. CPC H04L 67/34; H04L 61/2007; H04L 61/1511

(57) ABSTRACT

A system for fingerprinting operating system and/or other client software incorporates a server executing multiple logical servers, a data storage unit and DNS server. Upon receiving a client DNS query for resolving a domain name of a logical server, the DNS server provides multiple IP addresses for the server domain name. The order of the multiple IP addresses provided by the DNS server is changed in each DNS server response. The server then receives a request from the client using one of the IP addresses provided to the client by the DNS server. The information on the original order of the multiple IP addresses provided to the client by the DNS server and the one IP address chosen by the client for accessing the server are stored in the data storage. After accumulation of sufficient statistics, the stored data is analyzed and the client software fingerprint is created based thereon.

### BACKGROUND OF THE INVENTION

Field of the Invention

The disclosed embodiments relate in general to the field of networking technology and in particular to systems and methods for fingerprinting operating systems and software applications based on network resource access pattern.

Description of the Related Art

As a living person may be uniquely identified using features of his or her fingerprint, an operating system or other software application may likewise be accurately identified using its behavior and, in particular, the network communication behavior. By recording and analyzing the network communication patterns of network-attached devices, in many cases it is possible to determine the type of the network device (client, server, router, etc.) as well as the software being executed thereon. The term “fingerprinting” used in connection with identifying operating systems and other software applications refers to acquiring and analyzing information on application behavior for the aforesaid identification purpose.

Software fingerprinting may be useful, for example, for scanning the network to identify network-connected devices and for identifying potentially untrusted systems. Conventional software fingerprinting analysis usually involves analyzing network communication protocol flags, options, and data in the network packets that the device sends on to the network, and, therefore, it is a slow and complex process.

Therefore, new and improved systems and methods for fingerprinting operating systems and software applications based on network resource access patterns are needed.

### SUMMARY OF THE INVENTION

The inventive methodology is directed to methods and systems that substantially obviate one or more of the above and other problems associated with conventional techniques for fingerprinting operating systems and software applications.

In accordance with one aspect of the embodiments described herein, there is provided a computer-implemented method for determining a network resource access pattern of a client computer system, the computer-implemented method being performed in connection with a name server and server computer system including a central processing unit, a network interface and a memory, the server computer system including a plurality of logical servers, the computer-implemented method involving: in response to a domain name service request from the client computer system, using the name server to provide a plurality of ordered internet protocol addresses associated with one of the plurality of logical servers the to the client computer system; in response to a request from the client computer system to the one of the plurality of logical servers, the request including one of the plurality of the ordered internet protocol addresses associated with the one of the plurality of logical servers and a domain name of the one of the plurality of logical servers, storing in a storage device the one of the plurality of the ordered internet protocol addresses and the domain name of the one of the plurality of logical servers; redirecting the client computer system to another of the plurality of logical servers and repeating a. and b. for the another of the plurality of logical servers; and determining the network resource access pattern of a client computer system based on information on IP addresses and domain names stored in the storage device.

In one or more embodiments, the method further involves repeating the redirecting step until the storage device contains sufficient information on the IP addresses and domain names for determining the network resource access pattern of a client computer system.

In one or more embodiments, the method further involves rejecting the request from the client computer system to the one of the plurality of logical servers if the one of the plurality of the ordered internet protocol addresses contained in the request is a first address in the plurality of ordered internet protocol addresses.

In one or more embodiments, the method further involves changing an order of the plurality of the ordered internet protocol addresses associated with one of the plurality of logical servers.

In one or more embodiments, the method further involves generating a fingerprint of software on the client computer system based on the determined network resource access pattern of a client computer system.

In one or more embodiments, the method further involves sending data responsive to the request from the client computer system to the one of the plurality of logical servers when it is determined that the storage device contains sufficient information on the IP addresses and domain names for determining the network resource access pattern of a client computer system.

In one or more embodiments, the plurality of logical servers includes at least three logical servers.

In accordance with another aspect of the embodiments described herein, there is provided a non-transitory computer-readable medium embodying a set of computer-readable instructions, which, when executed in connection with a name server and server computer system including a central processing unit, a network interface and a memory, the server computer system including a plurality of logical servers, cause the name server and server computer system to perform a computer-implemented method for determining a network resource access pattern of a client computer system, the method involving: in response to a domain name service request from the client computer system, using the name server to provide a plurality of ordered internet protocol addresses associated with one of the plurality of logical servers the to the client computer system; in response to a request from the client computer system to the one of the plurality of logical servers, the request including one of the plurality of the ordered internet protocol addresses associated with the one of the plurality of logical servers and a domain name of the one of the plurality of logical servers, storing in a storage device the one of the plurality of the ordered internet protocol addresses and the domain name of the one of the plurality of logical servers; redirecting the client computer system to another of the plurality of logical servers and repeating a. and b. for the another of the plurality of logical servers; and determining the network resource access pattern of a client computer system based on information on IP addresses and domain names stored in the storage device.

In one or more embodiments, the method further involves repeating the redirecting step until the storage device contains sufficient information on the IP addresses and domain names for determining the network resource access pattern of a client computer system.

In one or more embodiments, the method further involves rejecting the request from the client computer system to the one of the plurality of logical servers if the one of the plurality of the ordered internet protocol addresses contained in the request is a first address in the plurality of ordered internet protocol addresses.

In one or more embodiments, the method further involves changing an order of the plurality of the ordered internet protocol addresses associated with one of the plurality of logical servers.

In one or more embodiments, the method further involves generating a fingerprint of software on the client computer system based on the determined network resource access pattern of a client computer system.

In one or more embodiments, the method further involves sending data responsive to the request from the client computer system to the one of the plurality of logical servers when it is determined that the storage device contains sufficient information on the IP addresses and domain names for determining the network resource access pattern of a client computer system.

In one or more embodiments, the plurality of logical servers includes at least three logical servers.

In accordance with yet another aspect of the embodiments described herein, there is provided a computerized system including a name server and server computer system including a central processing unit, a network interface and a memory, the server computer system including a plurality of logical servers, the memory storing a set of instructions for: in response to a domain name service request from the client computer system, using the name server to provide a plurality of ordered internet protocol addresses associated with one of the plurality of logical servers the to the client computer system; in response to a request from the client computer system to the one of the plurality of logical servers, the request including one of the plurality of the ordered internet protocol addresses associated with the one of the plurality of logical servers and a domain name of the one of the plurality of logical servers, storing in a storage device the one of the plurality of the ordered internet protocol addresses and the domain name of the one of the plurality of logical servers; redirecting the client computer system to another of the plurality of logical servers and repeating a. and b. for the another of the plurality of logical servers; and determining a network resource access pattern of a client computer system based on information on IP addresses and domain names stored in the storage device.

In one or more embodiments, the method further involves repeating the redirecting step until the storage device contains sufficient information on the IP addresses and domain names for determining the network resource access pattern of a client computer system.

In one or more embodiments, the method further involves rejecting the request from the client computer system to the one of the plurality of logical servers if the one of the plurality of the ordered internet protocol addresses contained in the request is a first address in the plurality of ordered internet protocol addresses.

In one or more embodiments, the method further involves changing an order of the plurality of the ordered internet protocol addresses associated with one of the plurality of logical servers.

In one or more embodiments, the method further involves generating a fingerprint of software on the client computer system based on the determined network resource access pattern of a client computer system.

In one or more embodiments, the method further involves sending data responsive to the request from the client computer system to the one of the plurality of logical servers when it is determined that the storage device contains sufficient information on the IP addresses and domain names for determining the network resource access pattern of a client computer system.

In one or more embodiments, the plurality of logical servers includes at least three logical servers.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a logical diagram of an exemplary embodiment of a distributed computerized system for fingerprinting client operating system and/or other client software based on network resource access patterns.

FIG. 2 provides a diagram illustrating command and data flows in an exemplary embodiment of the distributed computerized system for fingerprinting client operating system and/or other client software based on network resource access patterns.

FIG. 3 illustrates an exemplary operating sequence of an embodiment of the distributed computerized system for fingerprinting client operating system and/or other client software based on network resource access patterns.

FIG. 4 is a block diagram that illustrates an exemplary embodiment of the client computer system representing the client portion of the distributed computerized system for fingerprinting client operating system and/or other client software based on network resource access patterns.

FIG. 5 is a block diagram that illustrates an exemplary embodiment of the server computer system representing server portion of the distributed computerized system for fingerprinting client operating system and/or other client software based on network resource access patterns.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of a software running on a general purpose computer, in the form of a specialized hardware, or combination of software and hardware.

In accordance with one or more embodiments described herein, there are provided systems and methods for fingerprinting operating systems and software applications based on network resource access patterns. As would be appreciated by persons of ordinary skill in the art, when the domain name system (DNS) server returns multiple Internet protocol (IP) addresses for a domain name, there is no rule governing which of the provided addresses should be used for establishing the network connection. Thus, each operating system or other software running on a client uses its own algorithm for choosing one IP address from the multiple IP addresses provided by the DNS server. Accordingly, fingerprinting of the operating system and/or other software is possible based on how the aforesaid IP address is chosen.

In one or more embodiments, the inventive system for fingerprinting operating system and/or other client software incorporates a server executing multiple logical servers, a data storage unit and a DNS server. Upon receiving a client DNS query for resolving a domain name of a logical server, the DNS server is configured to provide multiple IP addresses for the server domain name. The order of the multiple IP addresses provided by the DNS server is changed in each DNS server response. The server then receives a request from the client using one of the IP addresses provided to the client by the DNS server. The information on the original order of the multiple IP addresses provided to the client by the DNS server and the one IP address chosen by the client for accessing the server are stored in the data storage. After accumulation of sufficient statistics, the stored data is analyzed and the client software fingerprint is created based thereon.

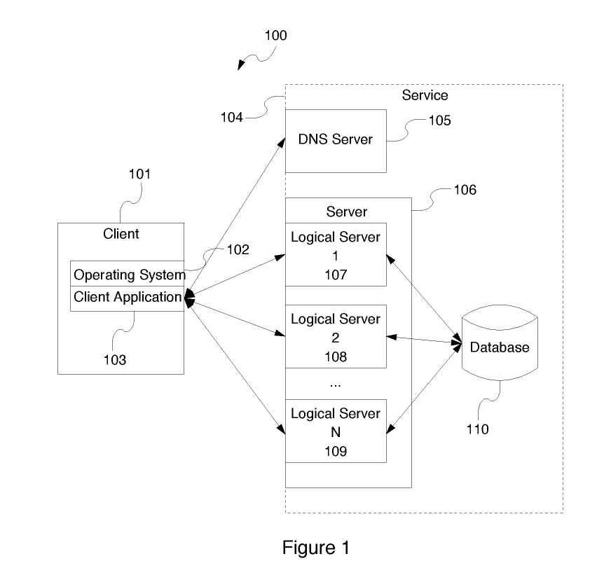

FIG. 1 illustrates a logical diagram of an exemplary embodiment of a distributed computerized system 100 for fingerprinting client operating system and/or other client software based on network resource access patterns. In the embodiment shown in FIG. 1, a client computer system 101 executes a client operating system 102 and a client software application 103. The client application 103 is any software application able to request data from a service 104 via network using the TCP/IP protocol, well known to persons of ordinary skill in the art. In one or more embodiments, the client software application 103 executing on the client computer system 101 is a web browser, such as Firefox, Google Chrome or Microsoft Internet Explorer or any other now known or later developed web browser. The service 104 is a computerized system accessible by the client computer system 101 via a network, which provides any type of useful functionality for the client computer system 101. In the embodiments shown in FIG. 1, the service 104 contains a DNS server 105, a server computer system 106 for providing functionality, and a data storage 110, such as a database system, for storing a various information. The server computer system 106 additionally executes an access pattern analysis application (not shown in FIG. 1), configured to analyze the network resource access patterns of the client software and obtain the fingerprint thereof.

In one or more embodiments, the DNS server 105 is a domain name system server, well known to persons of ordinary skill in the art, which manages names of logical servers 107, 108 and 109 used in the service 104. The aforesaid logical servers 107, 108 and 109 are deployed on the server computer system 106. The DNS server 105 is configured to allow for each logical server 107, 108 and 109 to resolve its respective domain name to a list of multiple pre-determined IP addresses. While in the example shown in FIG. 1 three logical servers 107, 108 and 109 are shown, it would be understood by persons of ordinary skill in the art that the invention is not limited to the shown number and any other number (N) of logical servers may be used in accordance with the techniques described herein. It should be noted that the aforesaid logical servers 1, 2, . . . N differ in their domain names, but they are assigned the same IP addresses.

In one or more embodiments, the server computer system 106 is a server system incorporated within the service 104 for handling the requests received via the network from the client computer system 101. The server computer system 106 is configured to monitor and record various information about the network activity of the client computer system 101. In one or more embodiments, the server computer system 106 is an HTTP server or webserver well known to persons of ordinary skill in the art.

In one or more embodiments, the server computer system 106 is associated with several IP addresses and logical server names corresponding to the logical servers 107, 108 and 109 deployed on the server computer system 106. For example, in one embodiment, the server computer system 106 may execute multiple instances of virtual servers. The service 104 makes various permutations of the multiple IP addresses assigned to the server computer system 106 and binds predetermined sequences of IP addresses to the logical server names of the logical servers 107, 108 and 109. For example, if the server computer system 106 is associated with three different IP addresses IP1, IP2, IP3, the following four unique sequences of IP addresses are used: IP1 IP2 IP3, IP1 IP3 IP2, IP3 IP1 IP2, IP3 IP2 IP1. As would be appreciated by persons of ordinary skill in the art, these four unique sequences may be assigned to four different logical servers and provided to the client by the DNS server 105 in response to domain name query for the respective logical server. As would be appreciated by persons of skill in the art, while the above example used three IP addresses, the invention is no so limited and any other number of IP addresses could be used for generating the IP address sequences assigned to the logical servers. The sequences of IP addresses assigned to various logical servers may be changed from time to time when either the IP addresses themselves are changed or when the order of IP addresses in the assigned sequence changes.

In one or more embodiments, the storage system 110 may be a local or network-attached storage system for storing and accumulating various information about the one or more client computer systems 101, their network activity and their network requests. In one embodiment, the storage 110 is a database system running on the server computer system 106 or a separate dedicated database server. In another embodiment, the storage system 110 is a file server, such as a network-attached file server, operating in accordance with NAS protocol. As would be appreciated by persons of ordinary skill in the art, the invention is not limited by any specific type or method of operation of the storage system 110.

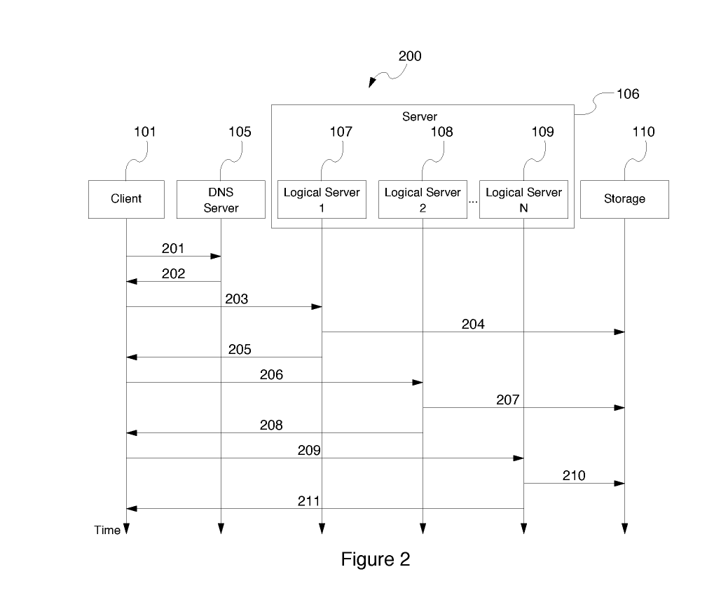

FIG. 2 provides a diagram 200 illustrating command and data flows in an exemplary embodiment of the distributed computerized system 100 for fingerprinting client operating system and/or other client software based on network resource access patterns. First, the client computer system 101 sends a DNS request 210 to the DNS server 105 querying the DNS records in order to resolve domain name of one of the logical servers 107, 108 and 109 and obtain the corresponding IP addresses. In response, the DNS server 105 sends a response 202 to the client computer system 101 containing the aforesaid ordered sequence of IP addresses assigned to the respective logical server.

After receiving the sequence of IP addresses from the DNS server 105, the client computer system 101 chooses one of the received IP addresses in accordance with its internal software algorithms and sends a data request 203 to the respective logical server. The client request 203 contains the name of the logical server (logical server 107 in the example shown in FIG. 2) and the IP address chosen by the client software. Upon receiving the client request 203, the logical server 107 stores at least the logical server name and the IP address from the request 203 in the storage 110 by means of a data storage request 204. The logical server 107 subsequently sends a response 205 to the client computer system 101 containing the requested information or a command formatted in accordance with the used communication protocol.

In one or more embodiments, the response 205 sent to the client computer system 101 by the logical server 107 redirects the client computer system 101 to another logical server deployed on the server computer system 106. This causes the client computer system 101 to send another DNS request 201 to resolve the domain name of the logical server the client computer system 101 was redirected to. After resolving the domain name of the new logical server (logical server 108), the client computer system 101 sends data request 206 to the respective logical server 108 using the IP address provided by the DNS server 105. Upon receiving the request 206 from the client computer system 101, the logical server 108 stores at least the logical server name and the IP address from the request 206 in the storage 110 by means of a data storage request 207. Subsequently, the logical server 108 sends a response 208 to the client computer system 101 redirecting the client computer system 101 to yet another logical server (logical server 109).

In a similar manner to the above-described process, after receiving the response 208, the client computer system 101 sends yet another DNS request 201 attempting to resolve the domain name of the logical server 109 that the client computer system 101 was redirected to. After resolving the domain name of the logical server 109, the client computer system 101 sends data request 209 to the respective logical server 109 using the IP address provided by the DNS server 105. Upon receiving the request 209 from the client computer system 101, the logical server 109 stores at least the logical server name and the IP address from the request 209 in the storage 110 using a data storage request 210. Subsequently, the logical server 108 sends a response 211 to the client computer system 101 either containing the data requested by the client or redirecting the client computer system 101 to yet another logical server (not shown). The above-described process may be repeated multiple times until sufficient statistics on the client computer system 101 access characteristics is accumulated in the data storage system 110. When sufficient statistics is accumulated, the data stored in the data storage system 110 is analyzed to determine the fingerprint of the software executing on the client computer system 101.

It should be noted that in addition to the IP addresses and the logical server domain names, the data storage system 110 may store a variety of other information regarding the client computer system 101, including, without limitation, the IP address of the client computer system 101, various options, protocol flags and the like.

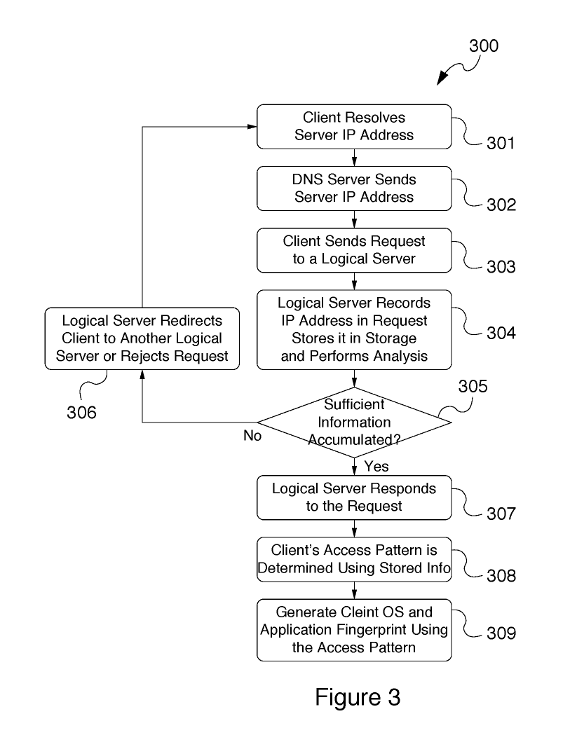

FIG. 3 illustrates an exemplary operating sequence 300 of an embodiment of the distributed computerized system 100 for fingerprinting client operating system and/or other client software based on network resource access patterns. First, at step 301, the client resolves the logical server domain name and obtains the corresponding IP address from the DNS server 105. To this end, the client computer system 101 sends a DNS request to the DNS server 105 and receives the appropriate response from the DNS server. The response from the DNS server contains an ordered sequence of IP addresses bound to the corresponding logical server name, see step 302. As would be appreciated by persons of ordinary skill in the art, in one embodiment, the communications between the client and the server described herein are initiated by the client computer system 101.

At step 303, the client computer system 101 selects one of the IP addresses received from the DNS server using the algorithm used by the client software and sends a request to the logical server at the selected IP address. As would be appreciated by persons of ordinary skill in the art, some of the client computer systems would use only the first IP address from the sequence of IP addresses, while other client systems would iterate sequentially over the sequence and try to connect and request data from each IP address. Some of the client systems could select the IP address using different and/or more sophisticated rules.

At step 304, the logical server receiving client request accepts the connection from the client computer system 101 and saves the IP address and the logical server name contained in the client's request in the data storage system 110. The logical server may also perform the analysis of the data accumulated in the storage system 110 to determine whether sufficient data on client's behavior has been accumulated, see step 305. If the data storage system 110 does not contain a sufficient amount of data, the logical server redirects the client computer system 101 to another logical server, see step 306. The redirection is necessary to force the client computer system 101 to connect to another logical server in order to accumulate more client behavior statistics. Alternatively, the logical server may reject the client connection request. In one or more embodiments, the client request is rejected when the client uses the very first IP address from the sequence of IP addresses returned by the DNS server. As would be appreciated by persons of skill in the art, rejection of the client request by the logical server forces the client to connect to the logical server using the second IP address from the sequence.

On the other hand, if sufficient data has been accumulated, the logical server handles the client request and sends the response containing information requested by the client, see step 307. Subsequently, at step 308, the server 106 identifies the IP address selection pattern used by the client while accessing the service 104. At step 309, the fingerprint of the client's software, including the client operating system 102 and/or client application(s) 103, is created using the statistics on the access pattern used by the client computer system 101 in accessing the service 104.

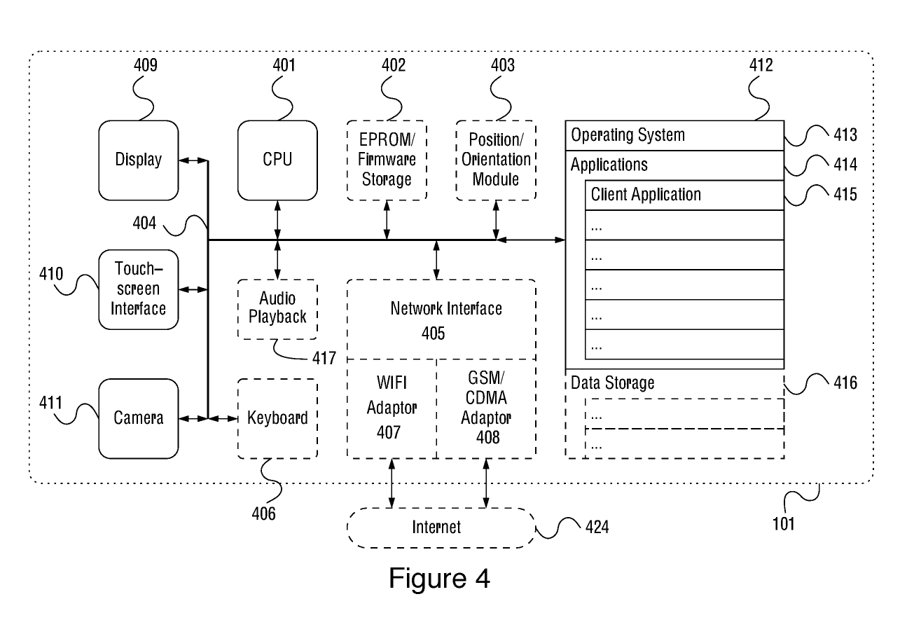

FIG. 4 is a block diagram that illustrates an exemplary embodiment of the client computer system 101 representing the client portion of the distributed computerized system 100 for fingerprinting client operating system and/or other client software based on network resource access patterns. In one or more embodiments, the client computer system 101 may be implemented within the form factor of a mobile computing device, such as a smartphone, a personal digital assistant (PDA), or a tablet computer, all of which are available commercially and are well known to persons of skill in the art. In an alternative embodiment, the client computer system 101 may be implemented based on a desktop, a laptop or a notebook computer. Yet in an alternative embodiment, the client computer system 101 may be an embedded system, incorporated into an electronic device with certain specialized functions, such as an electronic book (or e-book) reader. Yet in an alternative embodiment, the client computer system 101 may be implemented as a part of an augmented reality head-mounted display (HMD) systems, also well known to persons of ordinary skill in the art.

The client computer system 101 may include a data bus 404 or other interconnect or communication mechanism for communicating information across and among various hardware components of the client computer system 101, and a central processing unit (CPU or simply processor) 401 coupled with the data bus 404 for processing information and performing other computational and control tasks. Client computer system 101 also includes a memory 412, such as a random access memory (RAM) or other dynamic storage device, coupled to the data bus 404 for storing various information as well as instructions to be executed by the processor 401. The memory 412 may also include persistent storage devices, such as a magnetic disk, optical disk, solid-state flash memory device or other non-volatile solid-state storage devices.

In one or more embodiments, the memory 412 may also be used for storing temporary variables or other intermediate information during execution of instructions by the processor 401. Optionally, the client computer system 101 may further include a read only memory (ROM or EPROM) 402 or other static storage device coupled to the data bus 404 for storing static information and instructions for the processor 401, such as firmware necessary for the operation of the client computer system 101, basic input-output system (BIOS), as well as various configuration parameters of the client computer system 101.

In one or more embodiments, the client computer system 101 may incorporate a display device 409, which may be also coupled to the data bus 404, for displaying various information to a user of the client computer system 101. In an alternative embodiment, the display 409 may be associated with a graphics controller and/or graphics processor (not shown). The display device 409 may be implemented as a liquid crystal display (LCD), manufactured, for example, using a thin-film transistor (TFT) technology or an organic light emitting diode (OLED) technology, both of which are well known to persons of ordinary skill in the art. In various embodiments, the display device 409 may be incorporated into the same general enclosure with the remaining components of the client computer system 101. In an alternative embodiment, the display device 409 may be positioned outside of such enclosure.

In one or more embodiments, the display device 409 may be implemented in a form of a projector or a mini-projector configured to project information on various objects, such as glasses worn by the user. In one or more embodiments, the display device 409 may be configured to be mountable on the head of the user. To this end, the display device 409 may be provided with suitable mounting hardware (not shown).

In one or more embodiments, the client computer system 101 may further incorporate an audio playback device 417 connected to the data bus 404 and configured to play various audio files, such as MPEG-3 files, or audio tracks of various video files, such as MPEG-4 files, well known to persons of ordinary skill in the art. To this end, the client computer system 101 may also incorporate waive or sound processor or a similar device (not shown).

In one or more embodiments, the client computer system 101 may incorporate one or more input devices, such as a touchscreen interface 410 for receiving user's tactile commands, a camera 411 for acquiring still images and video of various objects, as well as a keyboard 406, which all may be coupled to the data bus 404 for communicating information, including, without limitation, images and video, as well as user command selections to the processor 401. In an alternative embodiment, input devices may include a system for tracking eye movements of the user (not shown), which may be used to indicate to the client computer system 101 the command selection made by the user.

In one or more embodiments, the client computer system 101 may additionally include a positioning and orientation module 403 configured to supply data on the current geographical position, spatial orientation as well as acceleration of the client computer mobile system 101 to the processor 401 via the data bus 404. The geographical position information may be obtained by the positioning module 403 using, for example, global positioning system (GPS) technology and/or other positioning techniques such as by using information provided by proximate cell towers and/or WIFI hotspots. The acceleration data is supplied by one or more accelerometers incorporated into the positioning and orientation module 403. Finally, the orientation information may be obtained using acceleration measurements in all 3 axes, including the gravity. In one or more embodiments, the position, orientation and acceleration metadata provided by the positioning and orientation module 403 is continuously recorded and stored in the data storage unit 417.

In one or more embodiments, the client computer system 101 may additionally include a communication interface, such as a network interface 405 coupled to the data bus 404. The network interface 405 may be configured to establish a connection between the client computer system 101 and the Internet 419 using at least one of WIFI interface 407 and the cellular network (GSM or CDMA) adaptor 408. The network interface 405 may be configured to provide a two-way data communication between the client computer system 101 and the Internet 424. The WIFI interface 407 may operate in compliance with 802.11a, 802.11b, 802.11g and/or 802.11n protocols as well as Bluetooth protocol well known to persons of ordinary skill in the art. In an exemplary implementation, the WIFI interface 407 and the cellular network (GSM or CDMA) adaptor 408 send and receive electrical or electromagnetic signals that carry digital data streams representing various types of information.

In one or more embodiments, the Internet 424 typically provides data communication through one or more sub-networks to other network resources. Thus, the client computer system 101 is capable of accessing a variety of network resources located anywhere on the Internet 424, such as remote media servers, web servers, other content servers as well as other network data storage resources. In one or more embodiments, the client computer system 101 is configured send and receive messages, media and other data, including application program code, through a variety of network(s) including Internet 424 by means of the network interface 405. In the Internet example, when the client computer system 101 acts as a network client, it may request code or data for an application program executing on the client computer system 101. Similarly, it may send various data or computer code to other network resources.

In one or more embodiments, the functionality described herein is implemented by client computer system 101 in response to processor 401 executing one or more sequences of one or more instructions contained in the memory 412. Such instructions may be read into the memory 412 from another computer-readable medium. Execution of the sequences of instructions contained in the memory 412 causes the processor 401 to perform the various process steps described herein. In alternative embodiments, hard-wired circuitry may be used in place of or in combination with software instructions to implement the embodiments invention. Thus, embodiments of the invention are not limited to any specific combination of hardware circuitry and software.

The term “computer-readable medium” as used herein refers to any medium that participates in providing instructions to processor 401 for execution. The computer-readable medium is just one example of a machine-readable medium, which may carry instructions for implementing any of the methods and/or techniques described herein. Such a medium may take many forms, including but not limited to, non-volatile media and volatile media.

Common forms of non-transitory computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, an EPROM, a FLASH-EPROM, a flash drive, a memory card, any other memory chip or cartridge, or any other medium from which a computer can read. Various forms of computer readable media may be involved in carrying one or more sequences of one or more instructions to processor 401 for execution. For example, the instructions may initially be carried on a magnetic disk from a remote computer. Alternatively, a remote computer can load the instructions into its dynamic memory and send the instructions over the Internet 424. Specifically, the computer instructions may be downloaded into the memory 412 of the client computer system 101 from the foresaid remote computer via the Internet 424 using a variety of network data communication protocols well known in the art.

In one or more embodiments, the memory 412 of the client computer system 101 may store any of the following software programs, applications or modules:

1. Operating system (OS) 413, which may be a mobile operating system for implementing basic system services and managing various hardware components of the client computer system 101. Exemplary embodiments of the operating system 413 are well known to persons of skill in the art, and may include Apple iOS, Google Android, Microsoft Windows Mobile or any now known or later developed mobile operating systems.

2. Applications 414, which may be mobile applications, may include, for example, a set of software applications executed by the processor 401 of the client computer system 101, which cause the client computer system 101 to perform certain predetermined functions, such as acquire digital images using the camera 411 or play media files using the display 409 and/or an audio playback device 417. In one or more embodiments, the applications 414 may include the client application 415 configured to access the service 104.

3. Data storage 416 may be used, for example, for storing the sequences of IP addresses received by the client computer system 101 from the DNS server 105.

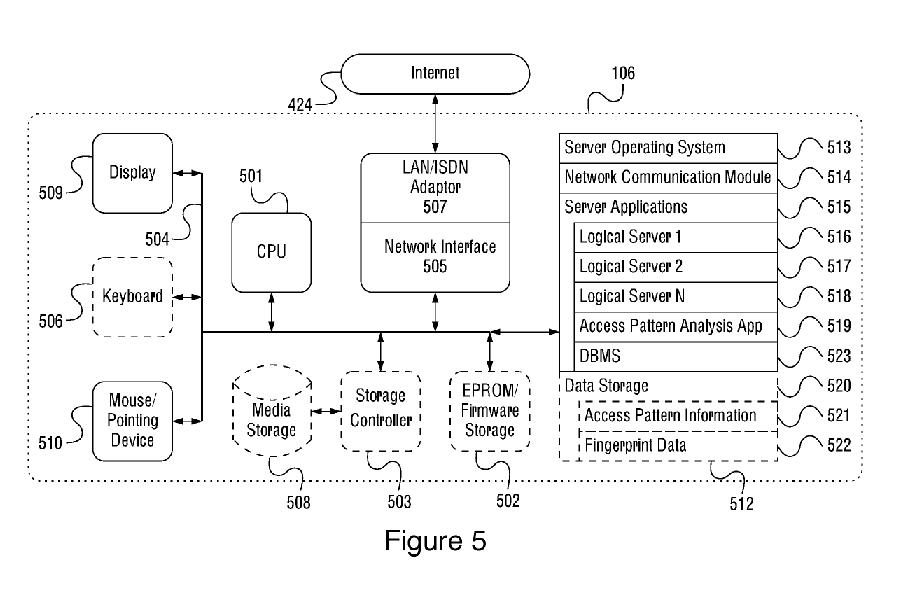

FIG. 5 is a block diagram that illustrates an exemplary embodiment of the server computer system 106 representing server portion of the distributed computerized system 100 for fingerprinting client operating system and/or other client software based on network resource access patterns.

In one or more embodiments, the server computer system 106 may incorporate a data bus 504, which may be substantially similar and may perform substantially similar functions as the data bus 404 of the client computer system 101 illustrated in FIG. 4. In various embodiments, the data bus 504 may use the same or different interconnect and/or communication protocol as the data bus 404. The one or more processors (CPUs) 501, the network interface 505, the EPROM/Firmware storage 502, the display 509 and the keyboard 506 of the server computer system 106 may be likewise substantially similar to the respective processor 401, the network interface 405, the EPROM/Firmware storage 402, the display 409 and the keyboard 406 of the client computer system 101, except that the former components are deployed in a server platform configuration. In various implementations, the one or more processor 501 may have substantially increased processing power as compared with the processor 401.

In addition to the input device 506 (keyboard), the server computer system 106 may additionally include a cursor control device 510, such as a mouse, a trackball, or cursor direction keys for communicating direction information and command selections to processor 501 and for controlling cursor movement on the display 509. This input device typically has two degrees of freedom in two axes, a first axis (e.g., x) and a second axis (e.g., y), that allows the device to specify positions in a plane.

The LAN/ISDN adaptor 507 of the server computer system 106 may be implemented, for example, using an integrated services digital network (ISDN) card or a modem to provide a data communication connection to a corresponding type of telephone line, which is interfaced with the Internet 424 using Internet service provider's hardware (not shown). As another example, the LAN/ISDN adaptor 507 may be a local area network interface card (LAN NIC) to provide a data communication connection to a compatible LAN and the Internet 424. To store various media files, the server computer system 106 may be provided with a media storage 508 connected to the data bus 504 by means of a storage controller 503.

In one or more embodiments, the memory 512 of the server computer system 106 may store any of the following software programs, applications or modules:

1. Server operating system (OS) 513, which may be an operating system for implementing basic system services and managing various hardware components of the server computer system 106. Exemplary embodiments of the server operating system 513 include, without limitation, Linux, Unix, Windows Server, FreeBSD, NetBSD, Mac OSX Server, HP-UX, AIX and Solaris, which are all well known to persons of skill in the art, as well as any other now known or later developed operating system.

2. Network communication module 514 may incorporate, for example, one or more network protocol stacks which are used to establish a networking connection between the server computer system 106 and the various network entities of the Internet 424, such as the client computer system 101, using the network interface 505 working in conjunction with the LAN/ISDN adaptor 507.

3. Server applications 515 may include, for example, a set of software applications executed by one or more processors 501 of the server computer system 106, which cause the server computer system 106 to perform certain predetermined functions or tasks. In one or more embodiments, the server applications 515 may include two or more instances of logical servers 516, 517 and 518, a client access pattern analysis application 519 and a database management system (DBMS) 523 including a set of software programs enabling storage, modification, and extraction of various data from the database 110 shown in FIG. 1. The database management system 523 may be implemented based on any now known or later developed type of database software, such as a relational database management system, including, without limitation, MySQL, Oracle, SQL Server, DB2, SQL Anywhere, PostgreSQL, SQLite, Firebird and/or MaxDB, which are well-known to persons of skill in the art. In an alternative embodiment, a cloud-based distributed database, such as Amazon Relational Database Service (Amazon RDS), well known to persons of ordinary skill in the art, may also be used to implement the database management system 523. In one or more embodiments, the aforesaid logical servers 516, 517 and 518 may be of any known of later developed type, including, without limitation, Apache, Microsoft IIS, nginx, Google GWS, lighttpd and Sun Microsystems SunOne.

4. Data storage 520 may be used, for example, for storing database tables managed by the database management system 523. The information stored in the aforesaid database tables may include detected client access pattern information 521 and the client operating system and/or other client software fingerprint data 522.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, Objective-C, perl, shell, PHP, Java, as well as any now known or later developed programming or scripting language.

Moreover, other implementations of the invention will be apparent to those skilled in the art from consideration of the specification and practice of the invention disclosed herein. Various aspects and/or components of the described embodiments may be used singly or in any combination in the computerized systems and methods for fingerprinting operating systems and software applications. It is intended that the specification and examples be considered as exemplary only, with a true scope and spirit of the invention being indicated by the following claims.

What is claimed is:

1. A computer-implemented method for determining a network resource access pattern of a client computer system, the computer-implemented method being performed in connection with a name server and server computer system comprising a central processing unit, a network interface and a memory, the server computer system comprising a plurality of logical servers, the computer-implemented method comprising:
a. in response to a domain name service request from the client computer system, using the name server to provide a plurality of ordered internet protocol addresses associated with one of the plurality of logical servers the to the client computer system;
b. in response to a request from the client computer system to the one of the plurality of logical servers, the request comprising one of the plurality of the ordered internet protocol addresses associated with the one of the plurality of logical servers and a domain name of the one of the plurality of logical servers, storing in a storage device the one of the plurality of the ordered internet protocol addresses and the domain name of the one of the plurality of logical servers;
c. redirecting the client computer system to another of the plurality of logical servers and repeating a. and b. for the another of the plurality of logical servers; and
d. determining the network resource access pattern of a client computer system based on information on IP addresses and domain names stored in the storage device.

2. The computer-implemented method of claim 1, further comprising repeating c. until the storage device contains sufficient information on the IP addresses and domain names for determining the network resource access pattern of a client computer system.

3. The computer-implemented method of claim 1, further comprising rejecting the request from the client computer system to the one of the plurality of logical servers if the one of the plurality of the ordered internet protocol addresses contained in the request is a first address in the plurality of ordered internet protocol addresses.

4. The computer-implemented method of claim 1, further comprising changing an order of the plurality of the ordered internet protocol addresses associated with one of the plurality of logical servers.

5. The computer-implemented method of claim 1, further comprising generating a fingerprint of software on the client computer system based on the determined network resource access pattern of a client computer system.

6. The computer-implemented method of claim 1, further comprising sending data responsive to the request from the client computer system to the one of the plurality of logical servers when it is determined that the storage device contains sufficient information on the IP addresses and domain names for determining the network resource access pattern of a client computer system.

7. The computer-implemented method of claim 1, wherein the plurality of logical servers comprises at least three logical servers.

8. A non-transitory computer-readable medium embodying a set of computer-readable instructions, which, when executed in connection with a name server and server computer system comprising a central processing unit, a network interface and a memory, the server computer system comprising a plurality of logical servers, cause the name server and server computer system to perform a computer-implemented method for determining a network resource access pattern of a client computer system, the method comprising:
a. in response to a domain name service request from the client computer system, using the name server to provide a plurality of ordered internet protocol addresses associated with one of the plurality of logical servers the to the client computer system;
b. in response to a request from the client computer system to the one of the plurality of logical servers, the request comprising one of the plurality of the ordered internet protocol addresses associated with the one of the plurality of logical servers and a domain name of the one of the plurality of logical servers, storing in a storage device the one of the plurality of the ordered internet protocol addresses and the domain name of the one of the plurality of logical servers;
c. redirecting the client computer system to another of the plurality of logical servers and repeating a. and b. for the another of the plurality of logical servers; and
d. determining the network resource access pattern of a client computer system based on information on IP addresses and domain names stored in the storage device.

9. The non-transitory computer-readable medium of claim 8, wherein the method further comprises repeating c. until the storage device contains sufficient information on the IP addresses and domain names for determining the network resource access pattern of a client computer system.

10. The non-transitory computer-readable medium of claim 8, wherein the method further comprises rejecting the request from the client computer system to the one of the plurality of logical servers if the one of the plurality of the ordered internet protocol addresses contained in the request is a first address in the plurality of ordered internet protocol addresses.

11. The non-transitory computer-readable medium of claim 8, wherein the method further comprises changing an order of the plurality of the ordered internet protocol addresses associated with one of the plurality of logical servers.

12. The non-transitory computer-readable medium of claim 8, wherein the method further comprises generating a fingerprint of software on the client computer system based on the determined network resource access pattern of a client computer system.

13. The non-transitory computer-readable medium of claim 8, wherein the method further comprises sending data responsive to the request from the client computer system to the one of the plurality of logical servers when it is determined that the storage device contains sufficient information on the IP addresses and domain names for determining the network resource access pattern of a client computer system.

14. The non-transitory computer-readable medium of claim 8, wherein the plurality of logical servers comprises at least three logical servers.

15. A computerized system comprising a name server and server computer system comprising a central processing unit, a network interface and a memory, the server computer system comprising a plurality of logical servers, the memory storing a set of instructions for:
a. in response to a domain name service request from the client computer system, using the name server to provide a plurality of ordered internet protocol addresses associated with one of the plurality of logical servers the to the client computer system;
b. in response to a request from the client computer system to the one of the plurality of logical servers, the request comprising one of the plurality of the ordered internet protocol addresses associated with the one of the plurality of logical servers and a domain name of the one of the plurality of logical servers, storing in a storage device the one of the plurality of the ordered internet protocol addresses and the domain name of the one of the plurality of logical servers;
c. redirecting the client computer system to another of the plurality of logical servers and repeating a. and b. for the another of the plurality of logical servers; and
d. determining a network resource access pattern of a client computer system based on information on IP addresses and domain names stored in the storage device.

16. The computerized system of claim 15, wherein the method further comprises repeating c. until the storage device contains sufficient information on the IP addresses and domain names for determining the network resource access pattern of a client computer system.

17. The computerized system of claim 15, wherein the method further comprises rejecting the request from the client computer system to the one of the plurality of logical servers if the one of the plurality of the ordered internet protocol addresses contained in the request is a first address in the plurality of ordered internet protocol addresses.

18. The computerized system of claim 15, wherein the method further comprises changing an order of the plurality of the ordered internet protocol addresses associated with one of the plurality of logical servers.

19. The computerized system of claim 15, wherein the method further comprises generating a fingerprint of software on the client computer system based on the determined network resource access pattern of a client computer system.

20. The computerized system of claim 15, wherein the method further comprises sending data responsive to the request from the client computer system to the one of the plurality of logical servers when it is determined that the storage device contains sufficient information on the IP addresses and domain names for determining the network resource access pattern of a client computer system.
